(19) United States
(12) Patent Application Publication
(10) Pub. No.: US 2003/0145690 A1
(43) Pub. Date: Aug. 7, 2003

(54) Tool for engaging and rotating a threaded fastener without damaging a surface finish or points of the fastener

(76) Inventor: Jerry A. Hartman, Gastonia, NC (US)

Correspondence Address: Adams, Schwartz & Evans, P.A., 2180 Two Wachovia Center, Charlotte, NC, 28282, US

(21) Appl. No.: 10/331,257

(22) Filed: Dec. 30, 2002

Related U.S. Application Data
(63) Continuation-in-part of application No. 10/061,609, filed on Feb. 1, 2002.

(51) Int. Cl. B25B 13/00

(52) U.S. Cl. 81/124.3

(57) ABSTRACT

A tool is adapted for rotating a threaded fastener having a plurality of circumferentially arranged flat areas separated by respective points. The tool includes a handle having first and second opposing ends. At least one of the first and second ends is a working end having an inner and outer perimeter. The inner perimeter defines a fastener-receiving opening adapted for receiving the threaded fastener. The outer perimeter defines at least one clip-receiving groove. The groove is adapted for receiving a portion of a locking clip located adjacent the fastener. The tool is applicable for rotating the fastener only when the portion of the locking clip is received within the groove. A plurality of cam surfaces are formed with the inner perimeter at the fastener-receiving opening, and are adapted for operatively engaging respective flat areas of the threaded fastener. A plurality of point pockets are formed between respective cam surfaces. The point pockets are adapted for receiving the points of the fastener to preserve the points when the fastener is rotated by the tool.

### TECHNICAL FIELD AND BACKGROUND OF INVENTION

This application relates to a hand tool, such as a wrench, adapted for engaging and rotating a threaded fastener without damaging the surface finish or points of the fastener. The invention is especially applicable for removing the external hinge bolts on the doors of a Jeep® Wrangler vehicle manufactured by Daimler Chrysler. Each hinge bolt is secured within the barrels of the door hinge by a threaded nut. The door of the vehicle is removed by first removing the threaded nut, and then sliding the hinge bolt out of the hinge barrels to free the door from the vehicle. For aesthetic reasons, the external door hinge, bolt, and nut are all painted to match the body color of the vehicle.

Jeep® Wrangler vehicles are commonly driven without the doors and top. In the process of removing the doors using a standard wrench, the paint on and around the external metal hinges is often damaged and/or quickly wears away. The worn areas expose a conspicuous and rather unsightly metallic surface which is generally inconvenient to repair. The threaded nut is especially prone to wear. In some cases, not only is the paint on the nut worn away, but the points become stripped requiring the nut to be replaced. The replacement nut is generally not painted, or, if painted, does not match the exact body color of the vehicle.

### SUMMARY OF INVENTION

Therefore, it is an object of the invention to provide a tool especially applicable for engaging and rotating a threaded fastener without damaging the surface finish or points of the fastener.

It is another object of the invention to provide a hand tool for rotating a threaded fastener which preserves the fastener by eliminating a direct shear force at the points of the fastener.

It is another object of the invention to provide a hand tool for rotating a threaded fastener without contacting the points of the fastener.

It is another object of the invention to provide a hand tool which includes a protective coating to avoid chipping or scratching painted surfaces.

It is another object of the invention to provide a hand tool which is especially applicable for removing the doors of a Jeep® Wrangler vehicle manufactured by Daimler Chrysler.

It is another object of the invention to provide a novel hand tool which is adapted specifically for use with a nut-locking clip, such that the clip prevents removal of the threaded nut using a conventional tool.

It is another object of the invention to provide a method for safeguarding the doors of a Jeep® Wrangler vehicle.

These and other objects of the present invention are achieved in the preferred embodiments disclosed below by providing a tool adapted for rotating a threaded fastener having a plurality of circumferentially arranged flat areas separated by respective points. The tool includes a handle having first and second opposing ends. At least one of the first and second ends defines a fastener-receiving opening. A plurality of cam surfaces are formed at the fastener-receiving opening, and are adapted for operatively engaging respective flat areas of the fastener. A plurality of point pockets are formed between respective cam surfaces, and are adapted for receiving the points of the fastener to preserve the points when the fastener is rotated by the tool.

According to another preferred embodiment of the invention, the fastener-receiving opening is defined by a closed box.

According to another preferred embodiment of the invention, the fastener-receiving opening is defined by a removable socket.

According to another preferred embodiment of the invention, the fastener-receiving opening is defined by a pair of spaced jaws.

According to another preferred embodiment of the invention, a protective coating is applied to the plurality of cam surfaces to further preserve the points of the fastener when rotated by the tool.

According to another preferred embodiment of the invention, the coating has a thickness greater than 2 mil.

According to another preferred embodiment of the invention, the coating includes an epoxy powder.

According to another preferred embodiment of the invention, the handle defines a keyway communicating with the fastener-receiving opening. The keyway is adapted for receiving a locking key attached adjacent the fastener. The tool is applicable for rotating the fastener only when the locking key is received within the keyway.

In another embodiment, the invention is a removable socket for being attached to a handle of a tool adapted for rotating a threaded fastener. The fastener has a plurality of circumferentially arranged flat areas separated by respective points. The socket defines a fastener-receiving opening, and a plurality of cam surfaces formed at the fastener-receiving opening. The cam surfaces are adapted for operatively engaging respective flat areas of the fastener. A plurality of point pockets are formed between respective cam surfaces, and are adapted for receiving the points of the fastener to preserve the points when the fastener is rotated by the tool.

In yet another embodiment, the invention is a method for preserving a surface finish on a threaded fastener. The fastener has a plurality of circumferentially arranged flat areas separated by respective points. The method includes the step of applying a tool to the fastener. The tool has at least two cam surfaces adapted for operatively engaging at least two flat areas of the fastener. The tool is pivoted to rotate the fastener in one of a clockwise and counterclockwise direction such that no portion of the tool engages the points of the fastener during rotation.

In yet another embodiment, the invention is a method for preserving a surface finish on a threaded fastener. The fastener has a plurality of circumferentially arranged flat areas separated by respective points. The method includes the step of applying a tool to the fastener. The tool has a protective coating formed on at least two cam surfaces adapted for engaging at least two flat areas of the fastener. The tool is pivoted to rotate the fastener in one of a clockwise and counterclockwise direction such that no portion of the tool engages the points of the fastener during rotation.

In yet another embodiment, the invention is a tool adapted for rotating a threaded fastener having a plurality of circumferentially arranged flat areas separated by respective points. The tool includes a handle having first and second opposing ends. At least one of the first and second ends is a working end having an inner and outer perimeter. The inner perimeter defines a fastener-receiving opening adapted for receiving the threaded fastener. The outer perimeter defines at least one clip-receiving groove adapted for receiving a portion of a locking clip located adjacent the fastener. The tool is applicable for rotating the fastener only when the portion of the locking clip is received within the groove. A plurality of cam surfaces are formed with the inner perimeter at the fastener-receiving opening, and are adapted for operatively engaging respective flat areas of the threaded fastener. A plurality of point pockets are formed between respective cam surfaces. The point pockets are adapted for receiving the points of the fastener to preserve the points when the fastener is rotated by the tool.

In yet another embodiment, the invention is a tool adapted for rotating a threaded fastener having a plurality of circumferentially arranged flat areas separated by respective points. The tool includes a handle having first and second opposing ends. At least one of the first and second ends is a working end having an inner and outer perimeter. The inner perimeter defines a fastener-receiving opening adapted for receiving the threaded fastener. The outer perimeter defines first and second clip-receiving grooves. The grooves are adapted for receiving respective first and second portions of a locking clip located adjacent the fastener. The tool is applicable for rotating the fastener only when the first and second portions of the locking clip are received within respective first and second grooves.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is an elevational view of a tool according to one preferred embodiment of the present invention;

FIG. 2 is an elevational view of a door hinge with the threaded nut removed from the hinge bolt;

FIG. 3 is an enlarged fragmentary view of the tool as applied to the fastener;

FIG. 4 is an elevational view of the tool according to a second preferred embodiment, and showing the longitudinal keyway formed in the handle of the tool;

FIG. 5 is an elevational view of the door hinge, and showing the locking clip carried on the hinge bolt and located between the threaded nut and hinge barrel;

FIG. 6 is an elevational view of the tool according to a third preferred embodiment;

FIG. 7 is plan view of a tool socket according to the present invention, and adapted for attachment to a conventional socket wrench;

FIG. 8 is a cross-sectional view of the tool socket taken substantially along line 8-8 of FIG. 7;

FIG. 9 is an elevational view of the tool according to yet another preferred embodiment of the invention;

FIG. 10 is a plan view of the nut locking clip adapted for use with the tool shown in FIG. 9;

FIG. 11 is a side view of the nut locking clip;

FIG. 12 is a side elevational view of the tool with the nut locking clip engaged;

FIG. 13 is a rear elevational view of the tool with the nut locking clip engaged; and

FIG. 14 is an enlarged, fragmentary plan view of the tool according to a further preferred embodiment of the present invention.

### DESCRIPTION OF THE PREFERRED EMBODIMENT AND BEST MODE

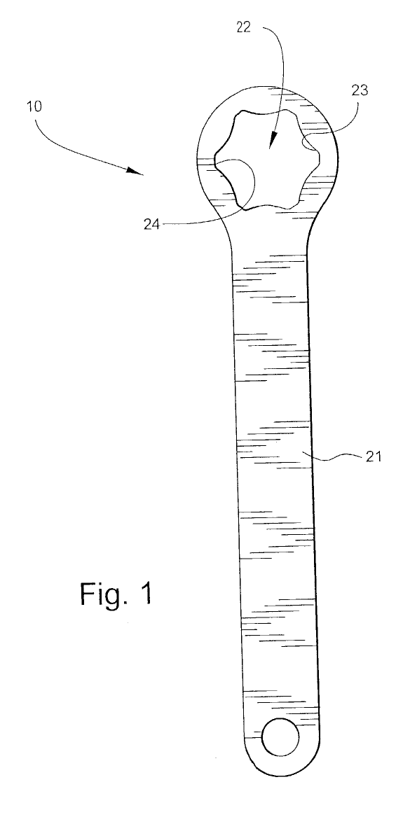

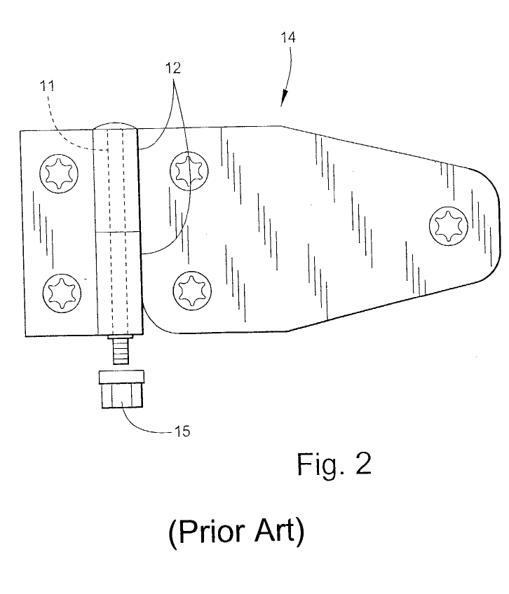

Referring now specifically to the drawings, a tool according to the present invention is illustrated in FIG. 1, and shown generally at reference numeral 10. The tool 10 is especially applicable for rotating a threaded fastener, such as a nut or bolt, without damaging the surface finish or points of the fastener. In one specific application discussed above, the tool 10 is used for removing hinge bolts on the door of a Jeep® Wrangler vehicle manufactured by Daimler Chrysler. As shown in FIG. 2, the hinge bolt 11 is secured within the barrels 12 of an external door hinge 14 by an internally-threaded nut 15 applied to a threaded end of the bolt 11. The nut 15, bolt 11, and hinge 14 are generally painted to match the body color of the vehicle. The present tool 10 is used to rotate the threaded nut 15 without chipping, scratching, or wearing away the painted surface on and around the nut 15. With the hinge bolts 11 removed, the door can be readily separated from the vehicle and stored.

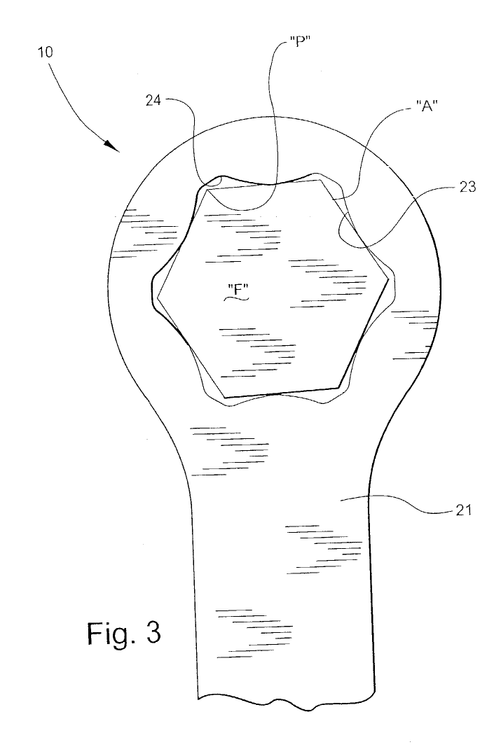

Referring to FIGS. 1 and 3, the tool 10 includes an elongated handle 21 having first and second opposite ends. At least one of the ends defines a boxed, fastener-receiving opening 22 and a number of spaced cam surfaces 23. The cam surfaces 23 are separated by pockets 24 adapted for receiving and protecting the points “P” of the fastener “F”, as shown in FIG. 3. When the tool 10 is rotated, the cam surfaces 23 bear against respective circumferentially-arranged flat areas “A” of the fastener “F” such that no portion of the tool 10 engages, the points “P”. The points “P” of the fastener “F” are preserved entirely within the pockets 24. For added protection, the entire tool 10 including the cam surfaces 23 is preferably coated with an epoxy powder having a gloss level of 90 on a 60 degree scale. The thickness of the coating is between 2 and 3 mils.

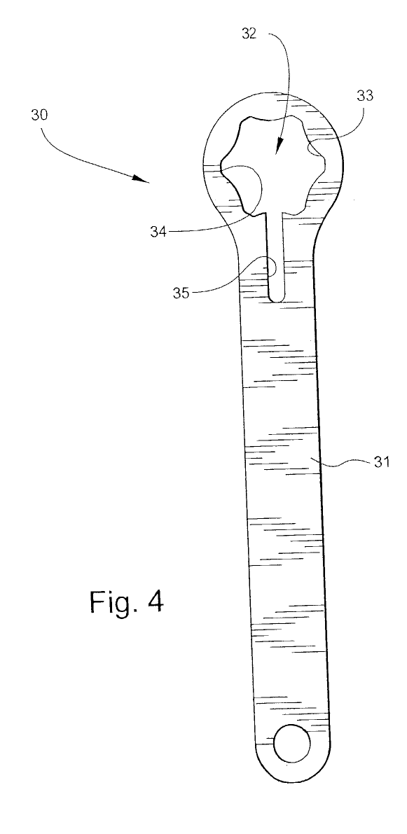

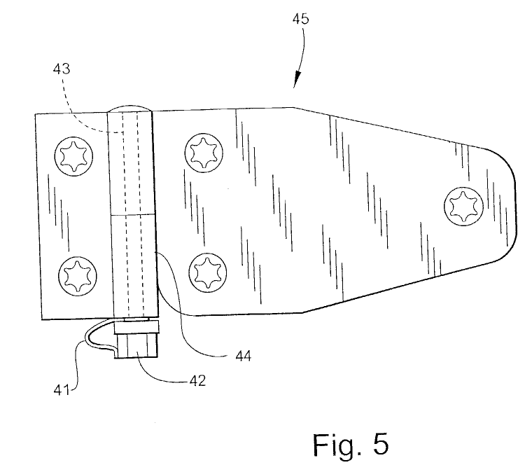

A further embodiment of the present invention is illustrated in FIG. 4. Like tool 10 described above, tool 30 includes an elongated handle 31 having first and second opposite ends. At least one of the ends defines a boxed, fastener-receiving opening 32 and a number of spaced cam surfaces 33. The cam surfaces 33 are separated by pockets 34 adapted for receiving and protecting the points of a fastener. A longitudinal keyway 35 communicating with the fastener-receiving opening 32 is formed in the handle 31 of the tool 30. The keyway 35 is designed to receive a metal-wire locking clip 41, shown in FIG. 5. The locking clip is rotatably carried on the hinge bolt 43 and located between the threaded nut 42 and hinge barrel 44 of the door hinge 45. In order to use the tool 30, the locking clip 41 must be inserted into the keyway 35. With the clip 41 in the keyway 35, the cam surfaces 33 of the tool 30 can be applied to the threaded nut 42 and the nut 42 rotated in a clockwise or counterclockwise direction to remove or secure the door to the vehicle. When the tool 30 is rotated, the cam surfaces 33 bear against respective flat areas of the nut 42, as previously described, such that no portion of the tool 30 engages the points. For added protection, the cam surfaces 33 are preferably coated with an epoxy powder.

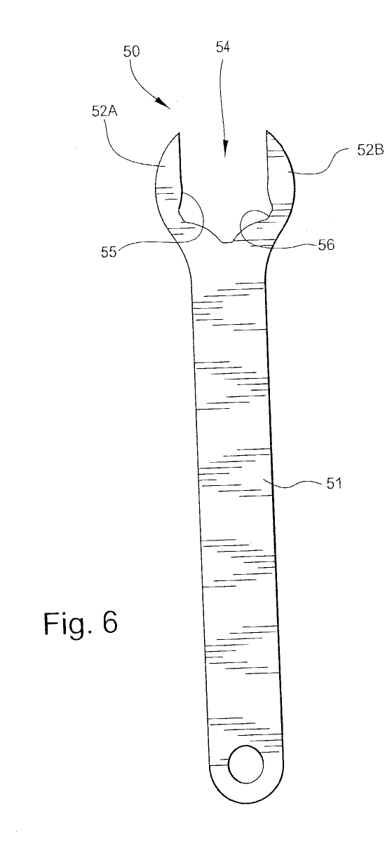

A third embodiment of the invention is shown in FIG. 6. The tool 50 includes an elongated handle 51 having first and second opposite ends. A pair of spaced jaws 52A and 52B are formed with at least one of the ends. The jaws 52A, 52B cooperate to form an open-end, fastener-receiving opening 54 and a number of spaced cam surfaces 55. The cam surfaces 55 are separated by pockets 56 adapted for receiving and protecting the points of a fastener. When the tool 50 is rotated, the cam surfaces 55 bear against respective flat areas of the fastener, as previously described, such that no portion of the tool 50 engages the points. The cam surfaces 55 are preferably coated with an epoxy powder.

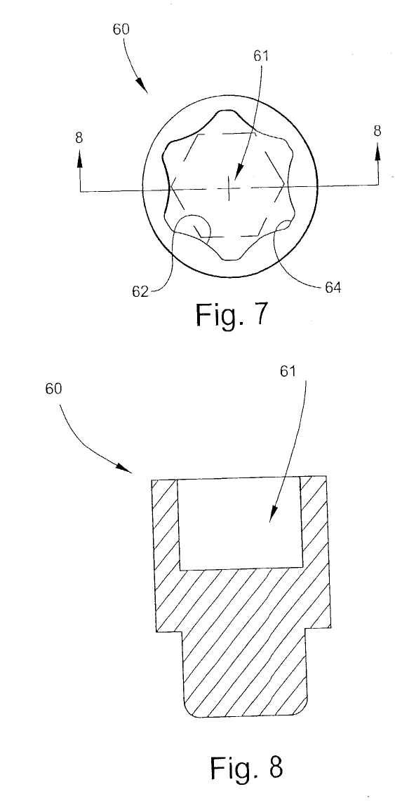

A removable tool socket 60 according to the invention is shown in FIGS. 7 and 8. The socket 60 is adapted for use with a conventional socket wrench. The socket 60 defines a fastener-receiving opening 61 and a number of spaced cam surfaces 62. The cam surfaces 62 are separated by pockets 64 adapted for receiving and protecting the points of a fastener. When the socket 60 is rotated, the cam surfaces 62 bear against respective flat areas of the fastener, as previously described, such that no portion of the socket 60 engages the points. The cam surfaces 62 of the socket 60 are preferably coated with an epoxy powder.

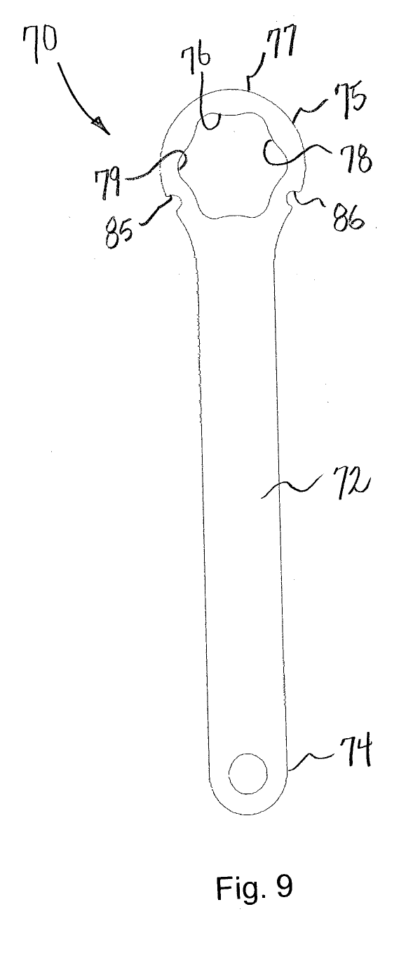

A further embodiment of a tool 70 and nut-locking clip 71 according to the present invention are illustrated in FIGS. 9-13. The nut-locking clip 71 is carried on a threaded hinge bolt, such as shown in FIG. 2. The hinge bolt is received within the barrel of a vehicle door hinge and cooperates with a threaded nut to secure a removable door to the vehicle, as previously described.

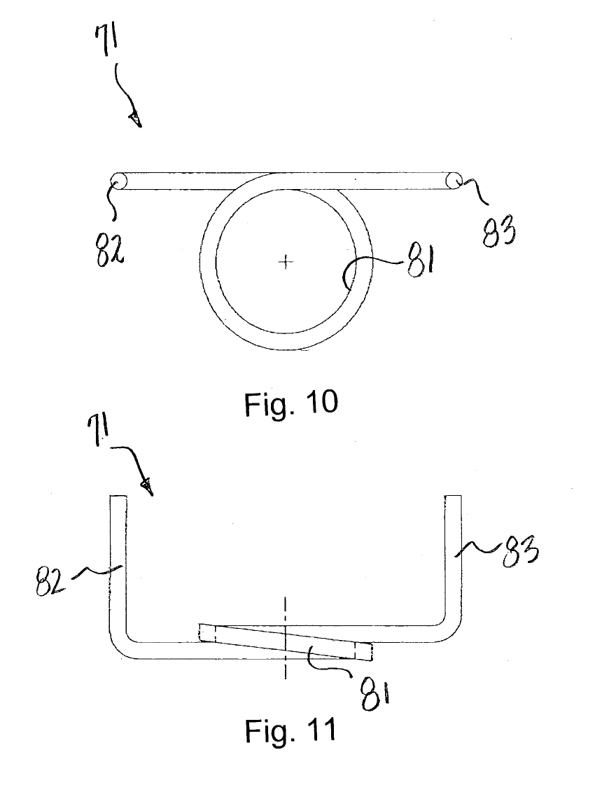

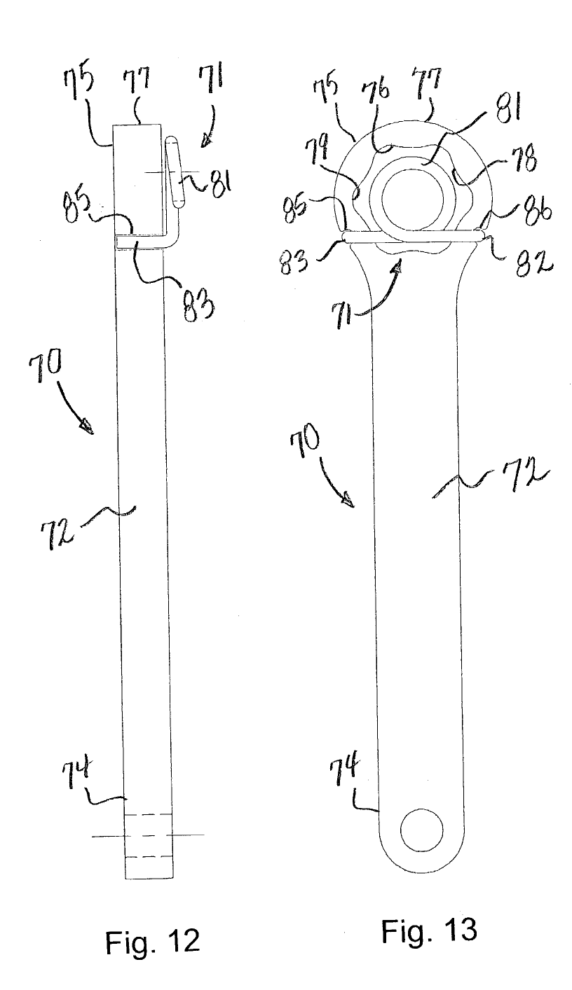

The tool 70 includes an elongated handle 72 having first and second opposite ends 74 and 75. The end 75 is a boxed working end having an inner and outer perimeter 76 and 77. The inner perimeter 76 defines a fastener-receiving opening and a number of spaced cam surfaces 78. The cam surfaces 78 are separated by pockets 79 adapted for receiving and protecting the points of the threaded nut. The nut-locking clip 71, best shown in FIGS. 10 and 11, is constructed of 0.06 stainless steel spring wire, and includes an integrally-formed annular body portion 81 adapted for encircling the hinge bolt and first and second leg portions 82 and 83 projecting 90 degrees outwardly from the body portion 81. The outer perimeter 77 of the working end 75 defines first and second clip-receiving grooves 85 and 86 intended to receive the first and second leg portions 82 and 83 of the nut-locking clip 71, as shown in FIGS. 12 and 13. The locking clip 71 is rotatably carried on the hinge bolt, and is located between the threaded nut and hinge barrel of the door hinge. In order to use the tool 70, the leg portions 82 and 83 of the nut-locking clip 71 must be positioned within the grooves 85 and 86. With the leg portions 82, 83 in the grooves 85, 86, the working end 75 of the tool 70 can be operatively applied to the threaded nut and the nut rotated in a clockwise or counterclockwise direction to remove or secure the door to the vehicle. When the tool 70 is rotated, the cam surfaces 78 bear against respective flat areas of the nut, as previously described, such that no portion of the tool 70 engages the points.

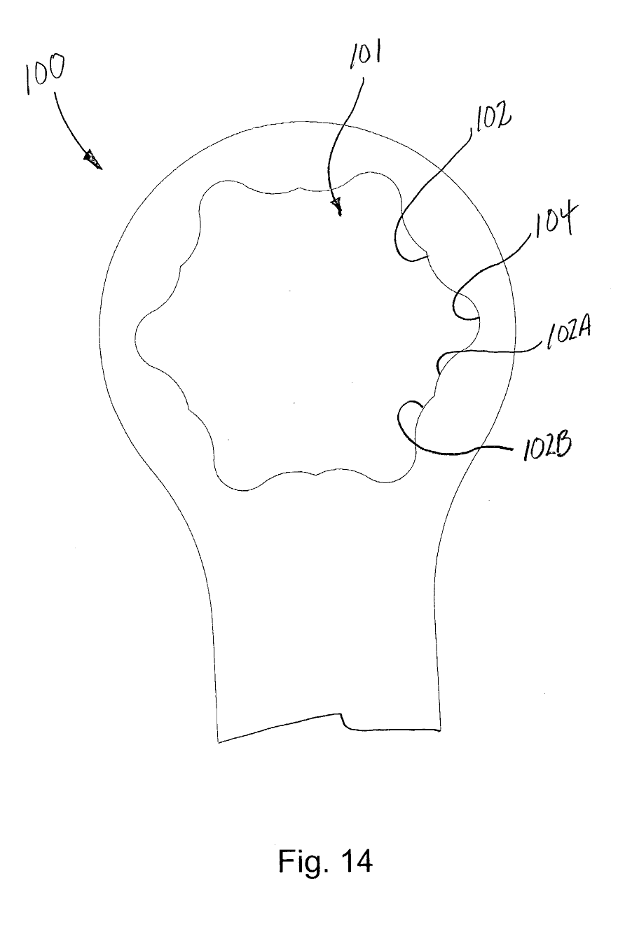

Yet another embodiment of a tool 100 according to the present invention is illustrated in FIG. 14. The tool 100 has a handle and opposing ends; one or both of which defines a boxed, fastener-receiving opening 101 and a number of spaced cam surfaces 102. The cam surfaces 102 are defined by respective double radii 102A and 102B, and are separated by pockets 104 adapted for receiving and protecting the points of the fastener. When the tool 100 is rotated, the double-radius cam surfaces 102 bear against respective circumferentially-arranged flat areas of the fastener such that no portion of the tool 100 engages the points. The points of the fastener are preserved entirely within the pockets 104. For added protection, the entire tool 100 including the cam surfaces 102 is preferably coated with an epoxy powder having a gloss level of 90 on a 60 degree scale. The thickness of the coating is between 2 and 3 mils.

A tool for rotating a threaded fastener is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A tool adapted for rotating a threaded fastener having a plurality of circumferentially arranged flat areas separated by respective points, said tool comprising:
(a) a handle having first and second opposing ends;
(b) at least one of said first and second ends comprising a working end having an inner and outer perimeter, said inner perimeter defining a fastener-receiving opening adapted for receiving the threaded fastener therein, and said outer perimeter defining at least one clip-receiving groove adapted for receiving a portion of a locking clip located adjacent the fastener, whereby said tool is applicable for rotating the fastener only when the portion of the locking clip is received within said groove;
(c) a plurality of cam surfaces formed with the inner perimeter at said fastener-receiving opening, and adapted for operatively engaging respective flat areas of the threaded fastener; and
(d) a plurality of point pockets formed between respective cam surfaces, and adapted for receiving the points of the fastener to preserve the points when the fastener is rotated by said tool.

2. A tool according to claim 1, wherein said fastener-receiving opening at said working end is defined by a closed box.

3. A tool according to claim 1, and comprising a protective coating applied to said plurality of cam surfaces to further preserve the points of the fastener when rotated by said tool.

4. A tool according to claim 3, wherein said coating has a thickness greater than 2 mil.

5. A tool according to claim 4, wherein said coating comprises an epoxy powder.

6. A tool according to claim 1, wherein said working end comprises first and second clip-receiving grooves formed with said outer perimeter and adapted for receiving respective first and second portions of the locking clip.

7. A tool adapted for rotating a threaded fastener having a plurality of circumferentially arranged flat areas separated by respective points, said tool comprising:
(a) a handle having first and second opposing ends; and
(b) at least one of said first and second ends comprising a working end having an inner and outer perimeter, said inner perimeter defining a fastener-receiving opening adapted for receiving the threaded fastener therein, and said outer perimeter defining at least one clip-receiving groove adapted for receiving a portion of a locking clip located adjacent the fastener, whereby said tool is applicable for rotating the fastener only when the portion of the locking clip is received within said groove.

8. A tool adapted for rotating a threaded fastener having a plurality of circumferentially arranged flat areas separated by respective points, said tool comprising:
(a) a handle having first and second opposing ends; and
(b) at least one of said first and second ends comprising a working end having an inner and outer perimeter, said inner perimeter defining a fastener-receiving opening adapted for receiving the threaded fastener therein, and said outer perimeter defining first and second clip-receiving grooves adapted for receiving respective first and second portions of a locking clip located adjacent the fastener, whereby said tool is applicable for rotating the fastener only when the first and second portions of the locking clip are received within respective first and second grooves.

9. A tool according to claim 8, wherein said fastener-receiving opening at said working end is defined by a closed box.

10. A tool according to claim 8, and comprising a protective coating applied to the inner perimeter of said working end to preserve the points of the fastener when rotated by said tool.

11. A tool according to claim 10, wherein said coating has a thickness greater than 2 mil.

12. A tool according to claim 10, wherein said coating comprises an epoxy powder.
